(19) United States
(12) Patent Application Publication
(10) Pub. No.: US 2025/0196813 A1
(43) Pub. Date: Jun. 19, 2025

(54) CONNECTION SYSTEM FOR A WINDSHIELD WIPER SYSTEM OF A VEHICLE

(71) Applicant: Robert Bosch GmbH, Stuttgart (DE)

(72) Inventors: Helmut Depondt, Boutersem (BE); Jan Bonroy, Leuven (BE)

(21) Appl. No.: 18/976,501

(22) Filed: Dec. 11, 2024

(30) Foreign Application Priority Data
Dec. 18, 2023 (DE) 10 2023 212 884.5

(51) Int. Cl. B60S 1/40; B60S 1/42

(52) U.S. Cl. CPC B60S 1/4003; B60S 1/42

(57) ABSTRACT

A connection system (150) for a windshield wiper (300) includes a wiper blade adapter (110) and a wiper arm adapter (120). The wiper blade adapter (110) is configured to receive a windshield wiper blade (100). The wiper blade adapter (110) and the wiper arm adapter (120) are rotatably connected to each other. The wiper arm adapter (120) includes a first connector structure (121, 122) and a second connector structure (123, 124) different from the first connector structure (121, 122). The first connector structure (121, 122) can be connected to the first connector end (210) of the windshield wiper arm, (200) and the second connector structure (123, 124) can be connected to a second connector end (220) of the windshield wiper arm (200) in a non-destructively releasable manner.

### BACKGROUND

The present invention relates to a connection system for a windshield wiper for a vehicle.

Currently, a variety of different solutions exist for connecting a windshield wiper arm to a windshield wiper blade. Such solutions typically include a connecting element that connects the windshield wiper arm to the windshield wiper blade. These connection elements differ significantly between different manufacturers. As a result, not every combination of a windshield wiper arm from one manufacturer can be connected to a windshield wiper blade from another manufacturer.

### SUMMARY

A connection system for a windshield wiper of a vehicle according to the disclosure has the advantage over what is known by several different windshield wiper arms being able to be connected to the same windshield wiper blade via the same adapter. This enables the same windshield wiper blade to be connected to different windshield wiper arms and thus to different vehicles.

According to the present invention, this is achieved by the connection system comprising a windshield wiper adapter and a wiper arm adapter. The windshield wiper adapter is configured to receive a windshield wiper blade. The wiper blade adapter and the wiper arm adapter are rotatably connected to one another and with one another. The windshield wiper arm adapter comprises a first connector structure and a second connector structure different from the first connector structure. The first connector structure can be connected to a first connector end of the windshield wiper arm in a non-destructively releasable manner. The second connector structure can be connected to a second connector end of the windshield wiper arm in a non-destructively releasable manner. In other words, a windshield wiper blade is arranged on a wiper blade adapter and, at the same time, the windshield wiper blade adapter can be received via a first connector structure of a windshield wiper arm comprising a first connector end, or connected via a second connector structure, a wiper arm comprising a second connecting end. As a result, the same windshield wiper blade can be received via the same connector adapter and connected to two different connector ends of a windshield wiper arm.

Preferably, the windshield wiper adapter comprises an axial stub. The wiper arm adapter comprises a bore. The bore is configured to receive the axial stub. One advantage of this embodiment may be that the wiper blade adapter and the wiper arm adapter are rotatably connected to each other via a simple mechanical design.

Advantageously, the first connector structure comprises a first connecting element and a second connecting element. The first connecting element can be connected to a third connecting element. The second connecting element can be connected to a fourth connecting element. The first connecting element and the second connecting element are configured to engage in the third connecting element and the fourth connecting element such that a relative movement of the wiper arm adapter to the first windshield wiper arm is blocked. One advantage of this embodiment may be that the first windshield wiper arm can be easily attached mechanically to the wiper arm adapter.

Advantageously, the second connector structure comprises a fifth connecting element and a sixth connecting element. The fifth connecting element is connected to a seventh connecting element of the second connector end. The sixth connecting element is connected to an eighth connecting element of the second connector end. The fifth connecting element and the sixth connecting element are configured to engage in the seventh connecting element and the eighth connecting element such that a relative movement between the wiper arm adapter and the windshield wiper arm is blocked. One advantage of this embodiment may be that it is a simple and reliable way of blocking the windshield wiper arm on the wiper arm adapter to prevent the windshield wiper arm from being unintentionally detached from the wiper arm adapter. In addition, this embodiment enables any desired adjustment of the first connecting element, the first connector end, the second connecting element, the fifth and sixth connecting elements, and the second connector end. The wiper arm adapter can therefore be adapted to any desired two connector ends of a windshield wiper arm.

Advantageously, the first connecting element is designed as a push-on mandrel. The wiper arm adapter comprises a pressure spring. The push-on mandrel is configured to fit through a push-on bore of the third connecting element. The pressure spring is configured to press the first windshield wiper arm against the push-on mandrel when the push-on mandrel is guided into the push-on bore. One advantage of this embodiment may be that the push-on mandrel and the insertion of the push-on bore onto the push-on mandrel prevent the first connector end from being pulled out of the wiper arm adapter. At the same time, the pressure spring causes the windshield wiper arm to not slip down from the push-on mandrel. As a result, unintentional detachment of the connection between the windshield wiper arm and the pressure spring is prevented.

Advantageously, the second connecting element is configured to engage in a recess of the fourth connecting element. The second connecting element is elastically supported in a windshield wiper arm. As a result, the second connecting element is able to latch into the recess of the fourth connecting element. By latching into the recess, a rotational movement of the first connector end about the push-on mandrel is prevented because the connecting element is retained by the fourth connecting element. This prevents the first connector end from being pulled off the windshield wiper arm adapter without the fourth connecting element first being pressed in. This also enables safe assembly and easy removal of the windshield wiper arm from the wiper arm adapter.

Particularly preferably, the fifth connecting element is designed as a latching element. The fifth connecting element is configured to fit into a recess of the seventh connecting element. The fifth connecting element is supported on the wiper arm adapter such that the fifth connecting element can be latched into the recess of the seventh connecting element. An advantage of this embodiment may be that pulling off the second connector end of the wiper arm in a first direction is prevented.

Particularly preferably, the sixth connecting element is designed as a latching element. The sixth connecting element is configured to fit into a recess of the eighth connecting element, whereby the sixth connecting element is elastically supported on the wiper arm adapter such that the sixth connecting element can be latched into the recess of the eighth connecting element. One advantage of this embodiment may be that the sixth connecting element blocks the connector end of the windshield wiper arm from being pulled off the wiper arm adapter by latching the eighth connecting element. The second connector end of the windshield wiper arm can only be achieved by pressing in the fifth connecting element or the sixth connecting element. Reliable mounting and easy removal of the connector end of the windshield wiper arm are enabled as a result.

Advantageously, the wiper arm adapter comprises a first outer side, a second outer side, and a third outer side. The first outer side and the third outer side connect to the second outer side. The first outer side and the third outer side are opposite each other. The first connecting element and the sixth connecting element are arranged on the second outer side. The second connecting element and the fifth connecting element are arranged on the first outer side and the third outer side. One advantage of this embodiment is a simple design of the wiper arm adapter. This reduces manufacturing costs, manufacturing effort, and facilitates a mounting operation of the wiper arm adapter.

Advantageously, the second connecting element can be latched into the fitting of the second connector end perpendicular to the third outer side. The pressure spring is pressed against the first connector end perpendicular to the second outer side when the first connector end is arranged on the wiper arm adapter. The fifth connecting element can be latched into the recess of the seventh connecting element perpendicular to the second outer side. The sixth connecting element can be latched into the recess of the eighth connecting element perpendicular to the third outer side. This enables a geometric and technically particularly simple implementation of the connection system.

Particularly preferably, the wiper arm adapter comprises a first inner side. The first inner side is arranged opposite the second outer side. The push-on mandrel is arranged on the first inner side. The wiper arm adapter comprises an opening which connects the second outer side to the first inner side. The pressure spring is arranged in this opening of the wiper arm adapter such that the third connecting element must be guided past the pressure spring on the push-on mandrel. One advantage of this embodiment is a particularly ergonomic insertion of the first connector end of the windshield wiper arm to the wiper arm adapter. As a result, the handling of the connection operation of the second connector end to the wiper arm adapter is simplified.

Preferably, the second connecting element interdependently with the fourth connecting element blocks a rotation of the first connector end and the first connecting element. The fifth connecting element, when inserted into the recess of the seventh connecting element, blocks a relative movement between the second connector end and the wiper arm adapter in a plane parallel to the second connector side. The first connecting element, when latched into the recess of the eighth connecting element, blocks a relative movement between the second connector end and the wiper arm adapter in the direction of the perpendicular of the second connector face. One advantage of this embodiment may be that unintentional detachment of the first connector end and/or the second connector end of the windshield wiper arm at the wiper arm adapter is prevented.

Preferably, the first outer side and the third outer side are at a distance such that, in a mounted state, the inner surface of the first connector end and/or the second connector end adjoin the first outer surface and the third outer surface. One advantage of this embodiment may be that this prevents movement of the first connector end or the second connector end relative to the perpendicular of the first outer surface and the third outer surface. As a result, an interlocking connection is created between the first connector end and/or the second connector end on the wiper arm adapter.

The invention further relates to a windshield wiper system comprising a first windshield wiper arm having a first connector end, a windshield wiper arm having a second connector end, a windshield wiper blade, and a connection system according to one of the previous embodiments. The wiper blade adapter is rotatably connected to the windshield wiper arm comprising the wiper arm adapter. The first connector end or the second connector end are connected to the wiper arm adapter in a non-destructively releasable manner. The first and second connector ends are different from each other. The advantages of this embodiment correspond to advantages of the previous embodiments.

The invention further relates to a vehicle comprising a windshield wiper system according to the previous embodiments. The vehicle has the advantages of the windshield wiper system embodiments specified hereinabove.

### BRIEF DESCRIPTION OF THE DRAWINGS

In the following, exemplary embodiments of the invention are described in detail with reference to the accompanying drawings. The drawings show:

FIG. 1 a schematic representation of a vehicle comprising a connection system according to one of the following exemplary embodiments of the invention,

FIG. 2 a schematic representation of a connection system according to a first exemplary embodiment of the invention comprising a first windshield wiper arm,

FIG. 3 a schematic representation of a connection system comprising a second windshield wiper arm according to the first exemplary embodiment of the invention,

FIG. 4 a schematic representation of a windshield wiper arm adapter according to the first exemplary embodiment of the invention,

FIG. 5 a schematic representation of a wiper arm adapter according to the first exemplary embodiment of the invention,

FIG. 6 a schematic representation of a windshield wiper arm comprising a first connector end according to one exemplary embodiment of the invention,

FIG. 7 a schematic illustration of a windshield wiper arm comprising a second connector end according to one exemplary embodiment of the invention,

FIG. 8 a schematic illustration of a connection system according to the first exemplary embodiment of the invention, in which the second connector end of the windshield wiper arm is pushed onto the connection system,

FIG. 9 a schematic illustration of a connection system according to an exemplary embodiment of the invention, in which a second connector end of the windshield wiper arm is already pushed onto the connection system,

FIG. 10 a schematic illustration of a connection system according to the first exemplary embodiment of the invention, onto which system a first connector end of the connection arm is pushed,

FIG. 11 a schematic illustration of a detailed view of the connection system according to one exemplary embodiment of the invention,

FIG. 12 a schematic illustration of a cross section of a connection system according to one exemplary embodiment of the invention, which system is connected to a second connector end of the windshield wiper arm, and

FIG. 13 a schematic illustration of a detailed view of the connection system according to one exemplary embodiment of the invention.

### DETAILED DESCRIPTION

Preferably, all elements, units, and/or assemblies in the drawings are provided with the same reference signs.

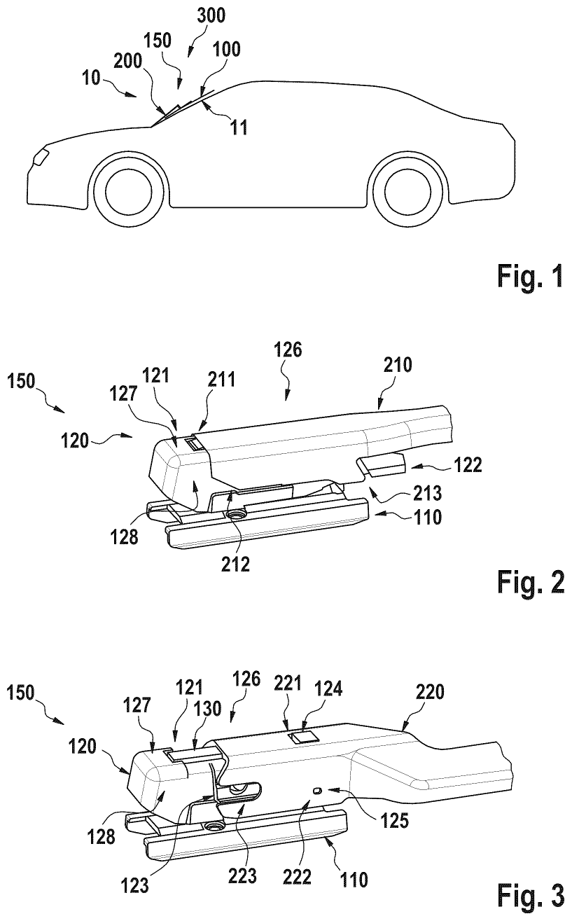

FIG. 1 shows a schematic illustration of a vehicle 10 comprising a connection system 150 according to one of the following exemplary embodiments of the invention. The vehicle 10 further comprises a windshield wiper system 300 having the connection system 150.

The windshield wiper system 300 comprises a windshield wiper arm 200 having a first connector end 210. Alternatively, the windshield wiper system 300 comprises the windshield wiper arm 200 having a second connector end 220. The windshield wiper system 300 comprises a windshield wiper blade 100. The windshield wiper system 300 also comprises a connection system 150 according to one of the following exemplary embodiments. The windshield wiper blade 100 is connected to the wiper blade adapter 110. The wiper blade adapter 110 is rotatably connected to the wiper arm adapter 120 comprising the wiper arm adapter 120. The first connector end 210 or the second connector end 220 is connected to the wiper arm adapter 120 in a non-destructively releasable manner. The first connector end 210 and the second connector end 220 are different from each other.

FIG. 2 shows a schematic representation of a connection system 150 according to a first exemplary embodiment of the invention comprising a first windshield wiper arm 200. The connection system 150 in FIG. 2 comprises features similar to the connection system 150 shown in FIG. 1. The connection system 150 comprises a wiper blade adapter 110 and a wiper arm adapter 120. The wiper blade adapter 110 is configured to receive a windshield wiper blade 100. The wiper blade adapter 110 and the wiper arm adapter 120 are rotatably connected to each other. The wiper arm adapter 120 comprises a first connector structure 121, 122 and a second connector structure 123, 124 different from the first connector structure 121, 122. The first connector structure 121, 122 can be connected to the first connector end 210 of the windshield wiper arm 200. The second connector structure 123, 124 can be connected to a second connector end 220 of the windshield wiper arm 200 in a non-destructively releasable manner.

The first connector structure 121, 122 comprises a first connecting element 121 and a second connecting element 122. The first connecting element 121 can be connected to a third connecting element 211 of the first connector end 210, and the second connecting element 122 can be connected to a fourth connecting element 213 of the first connector end 210. The first connecting element 121 and the second connecting element 122 are configured to engage in the third connecting element 211 and the fourth connecting element 213 such that a relative movement of the wiper arm adapter 120 to the wiper arm 200 can be blocked.

The first connecting element 121 is designed as a push-on mandrel. The wiper arm adapter 120 comprises a pressure spring 130. The push-on mandrel is configured to fit through a push-on bore 214 of the third connecting element 211. The pressure spring 130 is configured to press the windshield wiper arm 200 against the push-on mandrel when the push-on mandrel is guided into the push-on bore 214.

The second connecting element 122 is configured to engage in a recess of the fourth connecting element 213. The second connecting element 122 is elastically supported on the wiper arm adapter 120 such that the second connecting element 122 can be latched into the recess of the fourth connecting element 213. In FIG. 2, the first connector end 210 of the windshield wiper arm 200 is latched into the wiper arm adapter 120. As a result, the wiper arm adapter 120 must follow the movement of the first connector end 210.

FIG. 3 shows a schematic representation of a connection system 150 comprising a windshield wiper arm 200 according to the first exemplary embodiment of the invention. The second connector structure 123, 124 comprises a fifth connecting element 123 and a sixth connecting element 124. The fifth connecting element 123 can be connected to a seventh connecting element 223 of the second connector end 220. The sixth connecting element 124 can be connected to an eighth connecting element 221 of the second connector end 220. The fifth connecting element 123 and the sixth connecting element 124 are configured to engage in the seventh connecting element 223 and the eighth connecting element 221 such that a relative movement between the wiper arm adapter 120 and the windshield wiper arm 200 is blocked.

The fifth connecting element 123 is designed as a latching element. The fifth connecting element 123 is configured to fit into a recess of the seventh connecting element 223. The fifth connecting 123 is elastically supported on the wiper arm adapter 120 such that the fifth connecting element 123 can be latched into the recess of the seventh connecting element 223.

The sixth connecting element 124 is configured as a latching element. The sixth connecting element 124 is configured to fit into a recess of the eighth connecting element 221. The sixth connecting element 124 is elastically supported on the wiper arm adapter 120 such that the sixth connecting element 124 can be latched into the recess of the eighth connecting element 221.

A further latching element 222 supports the connection between the wiper arm adapter 120 and a second connector end 220.

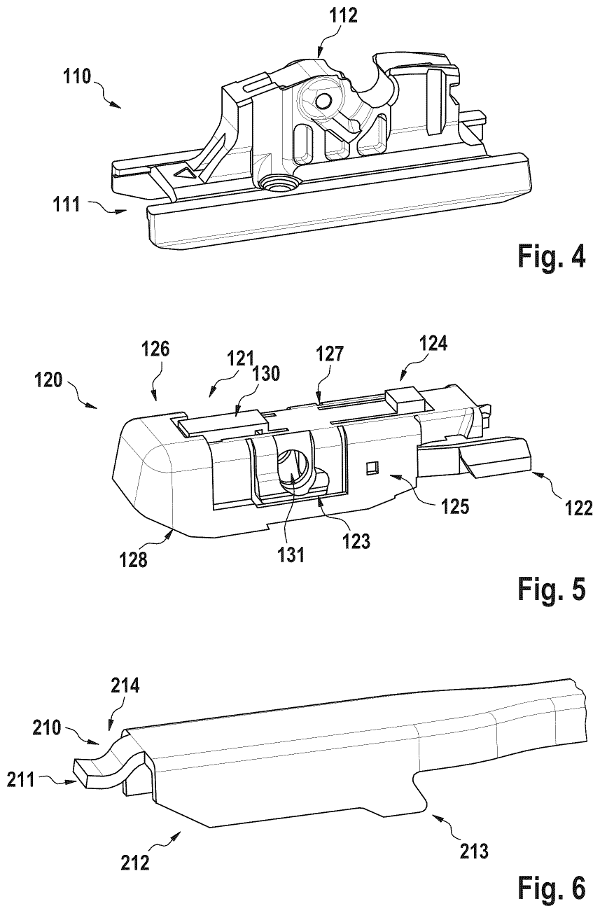

FIG. 4 shows a wiper blade adapter 110 according to a first exemplary embodiment of the invention. FIG. 4 comprises an area for receiving a windshield wiper blade 100. The windshield wiper adapter 110 comprises an axial stub 112. The wiper arm adapter 120 comprises a bore 131. The bore 131 is configured to receive the axial stub 112.

FIG. 5 shows a schematic representation of a wiper arm adapter 120 according to the first exemplary embodiment of the invention. The wiper arm adapter 120 comprises a bore 131, the bore 131 being configured to receive the axial stub 112. The wiper arm adapter 120 comprises a first outer side 126, a second outer side 127, and a third outer side 128. The first outer side 126 and the third outer side 128 connect to the second outer side 127. The first outer side 126 and the third outer side 128 are opposite each other. The first connecting element 121 and the sixth connecting element 124 are arranged on the second outer side 127. The second connecting element 122 and the fifth connecting element 123 are arranged on the first outer side 126 and the third outer side 128.

The second connecting element 122 can be latched into the recess of the second connector end 210 perpendicular to the third outer side 128. The pressure spring 130 can be pressed against the first connector end 210 perpendicular to the second outer side 127 when the first connector end 210 is arranged on the wiper arm 120. The fifth connecting element 123 can be latched into the recess of the seventh connecting element 223 perpendicular to the second outer side 127. The sixth connecting element 124 can be latched into the recess of the eighth connecting element 221 perpendicular to the third outer side 128.

The wiper arm adapter 120 comprises a first inner side 129, whereby the first inner side 129 is arranged opposite the second outer side 127. The push-on mandrel is arranged on the first inner side 129. The wiper arm adapter 120 comprises an opening in which the second outer side 127 is connected to the first inner side 129. The pressure spring 130 is arranged in this opening of the wiper arm adapter 120 such that the third connecting element 211 can be guided past the pressure spring 130 onto the push-on mandrel.

FIG. 6 shows a schematic representation of the wiper arm 200 comprising the first connector end 210 according to an exemplary embodiment of the invention. The first connector end 210 comprises a third connecting element 211 and a fourth connecting element 213. The third connecting element 211 is designed as a push-on bore 214. The push-on bore 214 is configured such that the push-on mandrel of the wiper arm adapter 120 can be received in the push-on bore 214.

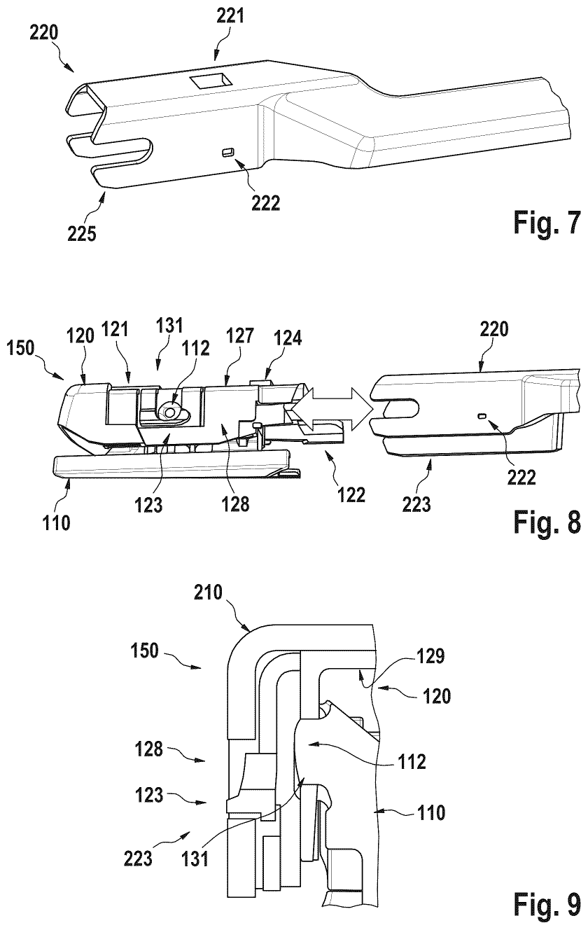

FIG. 7 shows a schematic representation of the windshield wiper arm 200 comprising the second connector end 220 according to one exemplary embodiment of the invention. The second connector end 220 comprises a seventh connecting element 221 and an eighth connecting element 223.

FIG. 8 shows a schematic representation of a connection system 150 according to the first exemplary embodiment of the invention. To mount the connector end 220, it is pushed onto the wiper arm adapter 120 in a longitudinal direction.

FIG. 9 shows a schematic representation of a connection system 150 according to a first exemplary embodiment of the invention. The first connector end 210 is pushed onto the wiper arm adapter 120. As clearly seen in FIG. 9, the fifth connecting element 123 engages into a recess of the seventh connecting element 223 and prevents a relative movement of the wiper arm adapter 120 to the second connector end 220.

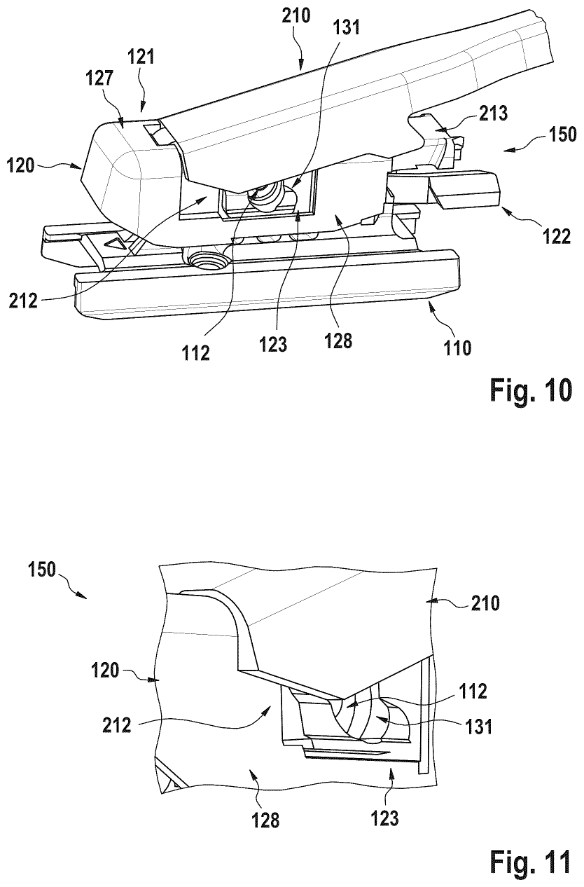

FIG. 10 shows a schematic illustration of a connection system 150 according to the first exemplary embodiment of the invention, onto which a first connector end of the connection arm has been pushed. To mount the first connector end 210, the third connecting element 213 of the push-on bore 214 is first pushed onto the push-on mandrel of the wiper arm adapter 120. The third connecting element is in this case pushed past the pressure spring. The pressure spring 130 is thereby deflected. The first connector end 210 is then lowered such that the second connecting element 122 of the wiper arm adapter 120 engages into the recess of the third connecting element 211 of the first connector end 210.

FIG. 11 shows is a schematic illustration of a detailed view of the connection system 150 according to one exemplary embodiment of the invention. Specifically, FIG. 11 shows a detailed view of the connection system 150 during the assembly of the first connector end 210 onto the wiper arm adapter 120.

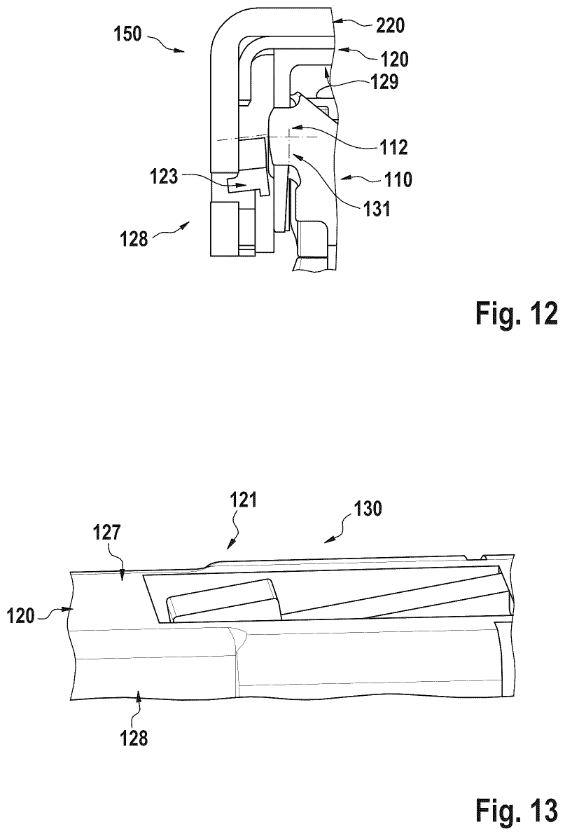

FIG. 12 shows a schematic representation of a cross section of a connection system 150 according to one exemplary embodiment of the invention, which system is connected to a second connector end 220 of the windshield wiper arm 200. As clearly seen, the second connector end 220 comprises no recess into which the fifth connecting element 123 could engage. Instead, the fifth connecting element 123 is pushed aside when the second connector end 220 is pushed onto the wiper arm adapter 120. A slope on the fifth connecting element 123 facilitates sliding of the fifth connecting element 123.

FIG. 13 shows a schematic illustration of a detailed view of the connection system 150 according to one exemplary embodiment of the invention. In FIG. 13, the pressure 130 of the wiper arm adapter 120 is shown pressed down. The pressure spring 130 is fixedly connected to the wiper arm adapter 120 only on one side.

1. A connection system (150) for a windshield wiper system (300) comprising:
a wiper blade adapter (110), and
a wiper arm adapter (120),
wherein the wiper blade adapter (110) is configured to receive a windshield wiper blade (100),
wherein the wiper blade adapter (110) and the wiper arm adapter (120) are rotatably connected to each other,
wherein the wiper arm adapter (120) comprises a first connector structure (121, 122) and a second connector structure (123, 124) different from the first connector structure (121, 122), and
wherein the first connector structure (121, 122) can be connected to a first connector end (210) of a windshield wiper arm (200), and the second connector structure (123, 124) can be connected to a second connector end (220) of the windshield wiper arm (200).

2. The connection system (150) according to claim 1, wherein
the wiper blade adapter (110) comprises an axial stub (112), and the wiper arm adapter (120) comprises a bore (131), wherein the bore (131) is configured to receive the axial stub (112).

3. The connection system (150) according to claim 1, wherein
the first connector structure (121, 122) comprises a first connecting element (121) and a second connecting element (122),
wherein the first connecting element (121) can be connected to a third connecting element (211) of the first connector end (210), and the second connecting element (122) can be connected to a fourth connecting element (213) of the first connector end (210), and
wherein the first connecting element (121) and the second connecting element (122) are configured to engage into the third connecting element (211) and the fourth connecting element (213) such that a relative movement of the wiper arm adapter (120) to the windshield wiper arm (200) can be blocked.

4. The connection system (150) according to claim 3, wherein
the second connector structure (123, 124) comprises a fifth connecting element (123) and a sixth connecting element (124),
wherein the fifth connecting element (123) can be connected to a seventh connecting element (223) of the second connector end (220), and the sixth connecting element (124) can be connected to an eighth connecting element (221) of the second connector end (220), and
wherein the fifth connecting element (123) and the sixth connecting element (124) are configured to engage in the seventh connecting element (223) and the eighth connecting element (221) such that a relative movement between the wiper arm adapter (120) and the windshield wiper arm (200) can be blocked.

5. The connection element (150) according to claim 3, wherein
the first connecting element (121) is configured as a push-on mandrel, and
the windshield wiper adapter (120) comprises a pressure spring (130),
wherein the push-on mandrel is configured to pass through a push-on bore (214) of the third connecting element (211), and
wherein the pressure spring (130) is configured to press the windshield wiper arm (200) against the push-on mandrel when the push-on mandrel is guided into the push-on bore (214).

6. The connection system (150) according to claim 3, wherein
the second connecting element (122) is configured to engage in a recess of the fourth connecting element (213),
wherein the second connecting element (122) is elastically supported on the wiper arm adapter (120) such that the second connecting element (122) can be latched into the recess of the fourth connecting element (213).

7. The connection system (150) according to claim 4, wherein
the fifth connecting element (123) is configured as a latching element,
wherein the fifth connecting element (123) is configured to fit into a recess of the seventh connecting element (223), and
wherein the fifth connecting element (123) is elastically supported on the wiper arm adapter (120) such that the fifth connecting element (123) can be latched into the recess of the seventh connecting element (223).

8. The connection system (150) according to claim 4, wherein
the sixth connecting element (124) is configured as a latching element,
wherein the sixth connecting element (124) is configured to fit into a recess of the eighth connecting element (221),
wherein the sixth connecting element (124) is elastically supported on the wiper arm adapter (120) such that the sixth connecting element (124) can be latched into the recess of the eighth connecting element (221).

9. The connecting element (150) according to claim 4, wherein
the wiper arm adapter (120) comprises a first outer side (126), a second outer side (127), and a third outer side (128),
wherein the first outer side (126) and the third outer side (128) connect to the second outer side (127),
wherein the first outer side (126) and the third outer side (128) are opposite each other,
wherein the first connecting element (121) and the sixth connecting element (124) are arranged on the second outer side (127), and
wherein the second connecting element (122) and the fifth connecting element (123) are arranged on the first outer side (126) and/or the third outer side (128).

10. The connection system (150) according to claim 9, wherein
the second connecting element (122) can be latched into a recess of the second connector end (210) perpendicular to the third outer side (128),
a pressure spring (130) presses against the first connector end (210) perpendicular to the second outer side (127) when the first connector end (210) is arranged on the wiper arm adapter (120),
the fifth connecting element (123) can be latched into a recess of the seventh connecting element (223) perpendicular to the second outer side (127), and
the sixth connecting element (124) can be latched into a recess of the eighth connecting element (221) perpendicular to the third outer side (128).

11. The connection system (150) according to claim 5, wherein
the wiper arm adapter (120) comprises a first outer side (126), a second outer side (127), a third outer side (128), and a first inner side (129),
wherein the first inner side (129) is arranged opposite the second outer side (127),
wherein the push-on mandrel is arranged on the first inner side (129),
wherein the wiper arm adapter (120) comprises an opening, in which the second outer side (127) connects to the first inner side (129), and
wherein the pressure spring (130) is arranged in the opening of the wiper arm adapter (120) such that the third connecting element (211) can be guided past the pressure spring (130) on the push-on mandrel.

12. The connection system (150) according to claim 7, wherein
the wiper arm adapter (120) comprises a first outer side (126), a second outer side (127), and a third outer side (128),
the second connecting element (124), in operative interaction with the fourth connecting element (213), blocks a rotation of the first connector end (210) and the first connecting element (121),
the fifth connecting element (123), when inserted into the recess of the seventh connecting element (223), blocks a relative movement between the second connector end (220) and the wiper arm adapter (120) in a plane parallel to the second outer side (127), and
the sixth connecting element (124), when latched into a recess of the eighth connecting element (221), blocks a relative movement between the second connector end (220) and the wiper arm adapter (120) in a direction perpendicular to the second outer side (127).

13. The connection system (150) according to claim 9, wherein the first outer side (126) and the third outer side (128) are at a distance from one another such that, in a mounted state, an inner surface of the first connector end (210) and/or the second connector end (220) adjoin(s) the first outer side (126) and the third outer side (128).

14. A windshield wiper system (300) comprising
a first wiper arm (200) having a first connector end (210), or
a second wiper arm (200) having a second connector end (220),
a windshield wiper blade (200), and
a connection system (150) according to claim 1,
wherein the windshield wiper blade (100) is connected to the wiper blade adapter (110),
wherein the wiper blade adapter (110) is rotatably connected to the wiper arm adapter (120),
wherein the first connector end (210) or the second connector end (220) is connected to the wiper arm adapter (120) in a non-destructively releasable manner, and
wherein the first connector end (210) and the second connector end (220) are different from each other.

15. A vehicle (10) comprising a windshield wiper system (300) according to claim 14.
